(19) United States
(12) Patent Application Publication
(10) Pub. No.: US 2014/0001021 A1
(43) Pub. Date: Jan. 2, 2014

(54) PRESS KEY

(71) Applicant: Qing ZHANG, Changshu (CN)

(72) Inventor: Qing ZHANG, Changshu (CN)

(21) Appl. No.: 13/534,686

(22) Filed: Jun. 27, 2012

(51) Int. Cl. H01H 13/50

(52) U.S. Cl. 200/5 C

(57) ABSTRACT

A press key includes: a circuit board including first and second switches; a pressing unit including a keycap disposed on the circuit board, and an elastic element disposed between the keycap and the circuit board, the keycap being normally in a raised position, and being able to be pressed to first and second pressed positions, the elastic element being capable of providing an elastic restoring force to restore the keycap to the raised position; and first and second trigger members that are spaced apart from each other and that are connected to the pressing unit to be able to move toward and contact the circuit board to turn on the first and second switches, respectively.

### BACKGROUND OF THE INVENTION

1. Field of the Invention

This invention relates to a press key, more particularly to a single press key capable of executing different commands.

2. Description of the Related Art

A conventional press key includes a base plate, a circuit board disposed on the base plate, a keycap disposed on the circuit board, and a rubber dome constantly providing an elastic restoring force and disposed between the keycap and the circuit board. The circuit board includes a switch for triggering a key signal. The rubber dome includes a pressing unit protruding downward and able to press the switch. While the rubber dome is elastically deformed, the pressing unit contacts and presses the switch of the circuit board so as to generate the key signal.

With the innovation of electronic products (such as, laptop, desktop computer and so on), the electronic products are required to have more functions, and thus the number of the press keys on the electronic products is increased. Excessive press keys occupy relatively large space, and result in an increased keyboard area on the electronic products.

Moreover, the current design trend is toward becoming thinner, lighter, smaller, and more portable. Thus, each of the press keys should be designed to have a smaller pressing area in accordance with the miniaturization of the electronic products. However, it is inconvenient for a user to press the press keys with smaller pressing areas. For example, the user may fail to precisely press the desired press keys or may mispress multiple press keys simultaneously.

Hence, there is a requirement to integrate multiple functions into a single press key. A multi-orientation press key has been proposed in Taiwanese Patent No. 1329331 to execute different commands. In this patent, two different positions on the multi-orientation press key can be pressed to turn on two different switches so as to generate different key signals. However, in order to provide two different pressing positions on the multi-orientation press key, the multi-orientation press key should have a relatively large pressing area. As such, the aim of reducing areas of press keys in the keyboard of the electronic product cannot be desirably achieved. Besides, because the user is accustomed to fast pressing a press key, the pressing of the multi-orientation press key does not conform with the typing habit of the user. Therefore, the multi-orientation press key is unfavorable for the miniaturization of the electronic products and for the fast typing.

### SUMMARY OF THE INVENTION

Therefore, an object of the present invention is to provide a press key that can overcome the aforesaid drawbacks associated with the prior art.

Accordingly, a press key according to this invention comprises:
a base plate;
a circuit board disposed on the base plate and including first and second switches;
a pressing unit including a keycap disposed on the circuit board, and an elastic element disposed between the keycap and the circuit board, the keycap being normally in a raised position, and being able to be pressed to first and second pressed positions, the elastic element being capable of providing an elastic restoring force to restore the keycap to the raised position; and
first and second trigger members that are spaced apart from each other, and that are connected to the pressing unit to be able to move toward and contact the circuit board to turn on the first and second switches, respectively, the first switch being turned on by the first trigger member when the keycap moves to the first pressed position, both of the first and second switches being turned on by the first and second trigger members when the keycap moves to the second pressed position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a cross-sectional exploded view of the first preferred embodiment of a press key according to the present invention;

FIG. 2 is a cross-sectional view of the first preferred embodiment in an assembled state;

FIG. 3 illustrates a keycap of the press key of the first preferred embodiment at a first pressed position;

FIG. 4 illustrates the keycap of the press key of the first preferred embodiment at a second pressed position;

FIG. 5 is a cross-sectional view of the second preferred embodiment of a press key according to the present invention;

FIG. 6 illustrates a keycap of the press key of the second preferred embodiment at a first pressed position; and

FIG. 7 illustrates the keycap of the press key of the second preferred embodiment at a second pressed position.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

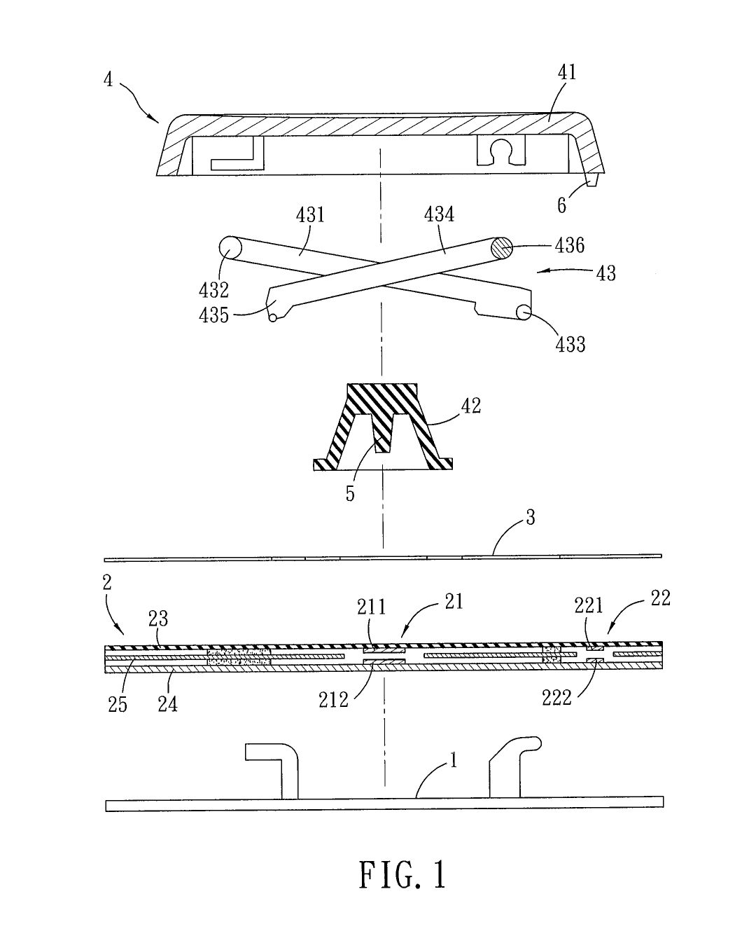

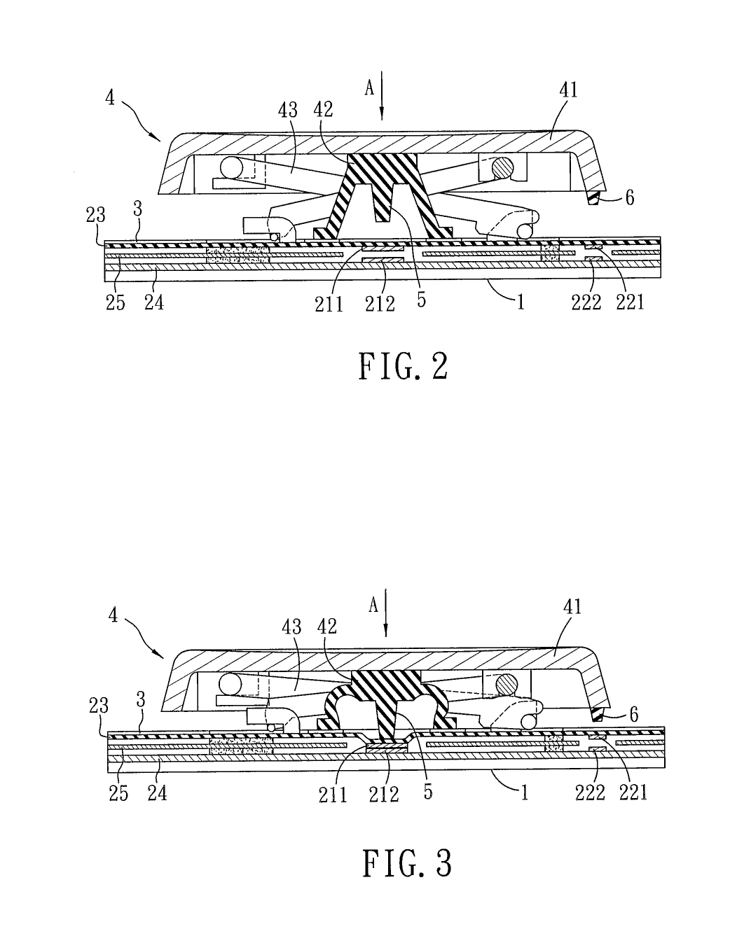

Referring to FIGS. 1 and 2, the first preferred embodiment of a press key according to this invention is shown to include a base plate 1, a circuit board 2, an insulating film 3, a press unit 4, and first and second trigger members 5, 6.

The circuit board 2 is disposed on the base plate 1 and includes first and second switches 21 and 22, a deformable upper layer 23, a lower layer 24, and a spacer unit 25 to space apart the upper and lower layers 23, 24.

The first and second switches 21, 22 are spaced apart from each other. The first switch 21 has an upper contact 211 disposed on a bottom surface of the upper layer 23, and a lower contact 212 disposed on a top surface of the lower layer 24. The lower contact 212 is spaced apart from the upper contact 211 and is aligned with the upper contact 211 along a direction shown by an arrow A. The second switch 22 has an upper contact 221 disposed on the bottom surface of the upper layer 23, and a lower contact 222 disposed on the top surface of the lower layer 24. The lower contact 222 is spaced apart from the upper contact 221 and is aligned with the upper contact 221 along the direction shown by the arrow A.

With the flexible deformation of the upper layer 23, the upper contact 211 of the first switch 21 can be brought into contact with the lower contact 212 of the first switch 21, and the upper contact 221 of the second switch 22 can be brought into contact with the lower contact 222 of the second switch 22. Alternatively, the first and second switches 21, 22 maybe replaced by other types of contact switches or sensitive switches (for example, capacitance switches).

The insulating film 3 is disposed on the circuit board 2, and is constituted by a mylar film. In other preferred embodiment, the insulating film 3 may be made of other insulation plastic materials.

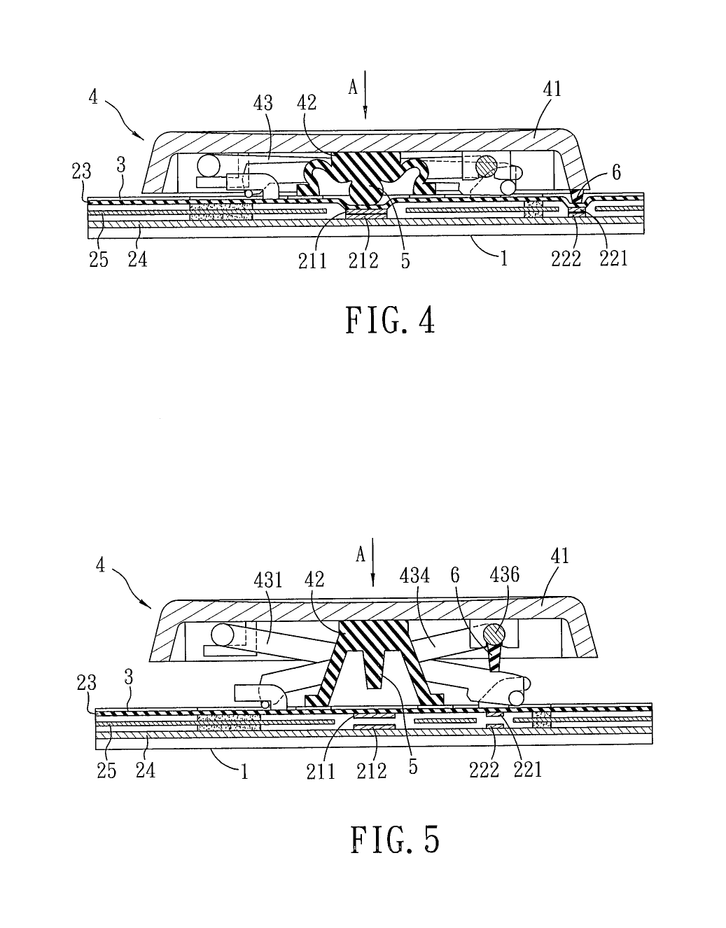

The pressing unit 4 includes a keycap 41 disposed on the circuit board 2, an elastic element 42 disposed between the keycap 41 and the circuit board 2, and a scissors-type linkage assembly 43 disposed between the keycap 41 and the base plate 1 to surround the elastic element 42. The keycap 41 is normally in a raised position (see FIG. 2), and is able to be pressed to a first position (FIG. 3) and a second pressed position (FIG. 4). The elastic element 42 is capable of providing an elastic restoring force to restore the keycap 41 to the raised position. In this embodiment, the elastic element 42 has an inverted bowl-shaped body made of a rubber material.

As best shown in FIG. 1, the scissors-type linkage assembly 43 includes intersecting first and second frame bodies 431, 434 that are pivotally connected to each other. Each of the first and second frame bodies 431, 434 has a generally rectangular shape. The first frame body 431 has a first upper end 432 that is pivotably connected to a lower surface of the keycap 41, and a first lower end 433 that is pivotally connected to an upper surface of the base plate 1. The second frame body 434 has a second lower end 435 that is pivotably connected to the upper surface of the base plate 1, and a second upper end 436 that is pivotally connected to the lower surface of the keycap 41.

In other embodiments, the scissors-type linkage assembly 43 may be replaced by other modified structures as long as the modified structures can stably guide the keycap 41 to move upward and downward with respect to the base plate 1.

The first and second trigger members 5 and 6 are spaced apart from each other, and are connected to the pressing unit 4 so as to be able to move toward and contact the circuit board 2, thereby turning on the first and second switches 21 and 22, respectively.

It should be noted that a distance between the first trigger member 5 and the first switch 21 is shorter than a distance between the second trigger member 6 and the second switch 22.

When an external force is applied to the keycap 41 to move the keycap 41 to the first pressed position (FIG. 3), the first trigger member 5 moves downwardly to contact the upper layer 23 so as to deform a first portion of the upper layer 23 that is at a position corresponding to the first trigger member 5. Accordingly, the upper contact 211 of the first switch 21 is brought into contact with the lower contact 212 of the first switch 21 by the first trigger member 5 to turn on the first switch 21, thereby generating a first key signal. At this moment, the second trigger member 6 is spaced apart from the second switch 22.

When a greater external force is applied to the keycap 41 to move the keycap 41 to the second pressed position (FIG. 4), both of the first and second trigger members 5 and 6 move downwardly to contact the upper layer 23 so as to deform the first portion and a second portion of the upper layer 23. The second portion of the upper layer 23 is at a position corresponding to the second trigger member 6. Accordingly, the upper contacts 211 and 221 of the first and second switches 21, 22 are respectively brought into contact with the lower contacts 212 and 222 of the first and second switches 21 and 22 by the first and second trigger members 5 and 6 to turn on both of the first and second switches 21 and 22, thereby generating a second key signal.

Accordingly, the press key of this invention can produce two different key signals by applying different amounts of force to move the keycap 41 to different positions. That is to say, in this invention, a single press key can be used to execute two different commands. In this embodiment, the first trigger member 5 is a protrusion extending downwardly from an inner surface of a top side of the inverted bowl-shaped body of the elastic member 42, and is formed in one-piece with the elastic element 42. Alternatively, the first trigger member 5 may be an independent element connected to the elastic element 42.

The second trigger member 6 is a protrusion extending downwardly from a lower side of the keycap 41, and is formed in one-piece with the keycap 41. Alternatively, the second trigger member 6 may be an independent element connected to the keycap 41.

In other embodiments, the circuit board 2 is a signal layer (not shown), and each of the first and second switches 21 and 22 has two spaced apart contacts (not shown) on the signal layer of the circuit board 2. Each of the first and second trigger members 5 and 6 has a conductive bottom end (not shown). When the first trigger member 5 moves to the first switch 21, the two spaced apart contacts are electrically connected through the first trigger member 5, thereby turning on the first switch 21. The second switch 22 can also be turned on in a similar manner.

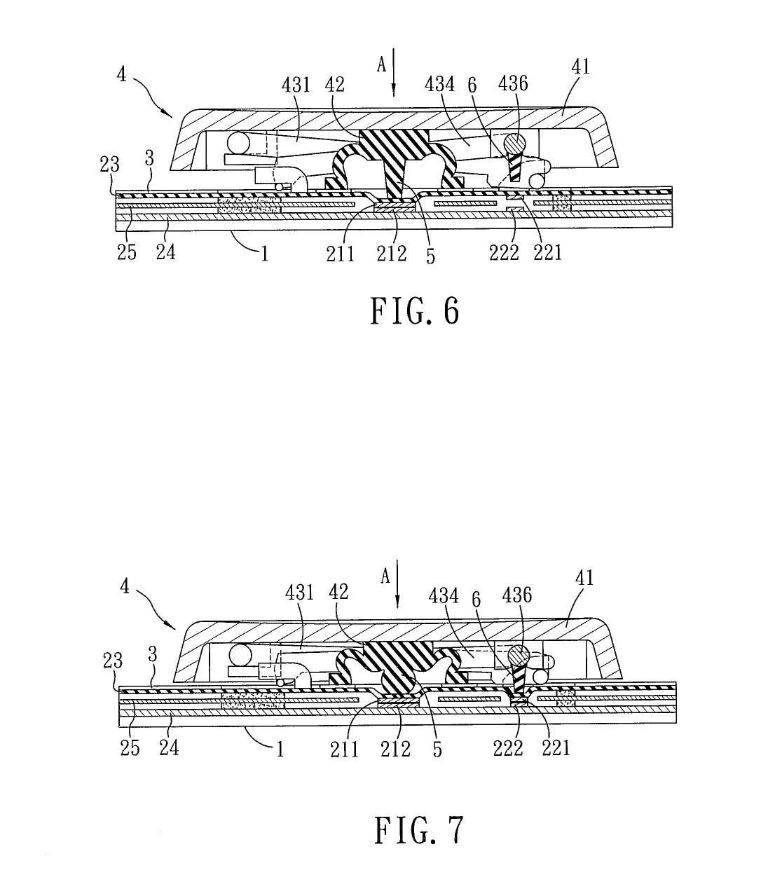

FIGS. 5 to 7 illustrate the second preferred embodiment of a press key according to this invention. The second preferred embodiment differs from the first preferred embodiment in that the second trigger member 6 of the second preferred embodiment is a protrusion extending downwardly from an upper side of the scissors-type linkage assembly 43. Specifically, the second trigger member 6 extends downwardly from the second upper end 436 of the second frame body 434.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A press key, comprising:
a base plate;
a circuit board disposed on said base plate and including first and second switches;
a pressing unit including a keycap disposed on said circuit board, and an elastic element disposed between said keycap and said circuit board, said keycap being normally in a raised position, and being able to be pressed to first and second pressed positions, said elastic element being capable of providing an elastic restoring force to restore said keycap to said raised position; and
first and second trigger members that are spaced apart from each other, and that are connected to said pressing unit to be able to move toward and contact said circuit board to turn on said first and second switches, respectively, said first switch being turned on by said first trigger member when said keycap moves to said first pressed position, both of said first and second switches being turned on by said first and second trigger members when said keycap moves to said second pressed position.

2. The press key of claim 1, wherein said circuit board further includes an upper layer, a lower layer and a spacer unit to space apart said upper and lower layers, each of said first and second switches having an upper contact disposed on a bottom surface of said upper layer, and a lower contact disposed on a top surface of said lower layer, said upper contact of said first switch being brought into contact with said lower contact of said first switch by said first trigger member to turn on said first switch when said keycap moves to said first pressed position, said upper contact of said second switch being brought into contact with said lower contact of said second switch by said second trigger member to turn on said second switch when said keycap moves to said second pressed position.

3. The press key of claim 2, wherein said elastic element has an inverted bowl-shaped body, and said first trigger member is a protrusion extending downwardly from an inner surface of a top side of said inverted bowl-shaped body.

4. The press key of claim 3, wherein said second trigger member is a protrusion extending downwardly from a lower side of said keycap.

5. The press key of claim 3, wherein said pressing unit further includes a scissors-type linkage assembly disposed between said keycap and said base plate.

6. The press key of claim 5, wherein said second trigger member is a protrusion extending downwardly from a lower side of said keycap.

7. The press key of claim 5, wherein said second trigger member is a protrusion extending downwardly from an upper side of said scissors-type linkage assembly.

8. The press key of claim 3, wherein said first trigger member is formed in one-piece with said elastic element.
